(19) United States
(12) Patent Application Publication
(10) Pub. No.: US 2007/0269763 A1
(43) Pub. Date: Nov. 22, 2007

(54) Orthodontic bracket

(76) Inventor: Claus Schendell-Groling, Gilching (DE)

Correspondence Address: JANSSON SHUPE & MUNGER LTD., 245 MAIN STREET, RACINE, WI, 53403, US

(21) Appl. No.: 11/436,273

(22) Filed: May 18, 2006

(51) Int. Cl. A61C 3/00

(52) U.S. Cl. 433/10

(57) ABSTRACT

An orthodontic bracket is disclosed, comprising: a base comprising a rear side for attachment to a tooth and a front side opposite to said rear side, a bracket main body extending from the front side of said base and having a first wing and a second wing, a groove-shaped archwire slot formed along a mesiodistal direction in the bracket main body, for holding an archwire therein between said first and second wings, a clip having a substantially belt shape and being curved substantially in a U-shape for covering at least one part of an opposite side to the base in the archwire slot, the clip having an end portion provided at an upper part thereof and a rotating supporter provided at a lower part thereof, said clip having a notch in a middle of its end portion, wherein the upper part of said clip at least partially covering the first wing has a length that does not extend beyond said archwire slot in a closing position of said clip, and said notch has a length that extends beyond said archwire slot in the closing position of said clip into a region occupied by said first wing delimiting one lateral side of said archwire slot.

### FIELD OF THE INVENTION

The present invention relate to an orthodontic bracket which, in particular, enables to secure a proper pressing-down force to an archwire inserted in an archwire slot for correcting malposition of teeth.

### BACKGROUND OF THE INVENTION

U.S. Pat. No. 6,776,613 to Orikasa discloses an orthodontic bracket which has a front side part, a bump portion, and an inner side part which are formed on a ceiling face of a guide portion in such a manner that the front side part, the bump portion and the inner side part are formed in order in a guiding direction to which a clip is guided by the guide portion. The bracket further has a sliding-rotation supporter provided at the lower end of the clip. When the sliding-rotation supporter slides on the ceiling face and gets over the pump portion from the front side part to reach the inner side part of the ceiling face, the end of the clip is caught in a in a recess under a cover portion of the bracket, so that the clip is secured against unintentional opening and the clip can press the archwire down toward the bottom of the archwire slot.

In the bracket of Orikasa, the clip is curved substantially in U-shape as covering at least one part of an opposite side to the base in the archwire slot. A catching end portion is provided at an upper part along the length direction of the clip and gets into a catching groove under a cover portion supported by the bracket main body. At its catching end portion, the clip is provided with a releasing recess for catching a desired instrument by means of which the clip may be moved from a closed position in which the archwire slot is closed by the clip so as to retain an archwire in said slot, into an open position in which the slot is exposed to enable a removal and exchange of the archwire. To prevent a movement of the clip in the mesiodistal direction of the bracket, the bracket main body comprises a central foot which is engaged from both sides by bifurcated end portions at a lower end of the clip. In the catching groove, a protrusion is formed which is engaged by the releasing recess in the closed position of the clip.

In the closed position of the clip, an undivided portion adjacent to the catching end portion of the clip engages an archwire inserted into the archwire slot to press same onto the bottom of said archwire slot. Therefore, if there is an inclination between the archwire and the bottom of the slot due to a malposition of the respective tooth, the clip engages the archwire with one edge of the clip only. Further due to the catching groove securing the catching end portion of the clip, the clip is unable to yield any excess stresses caused by the archwire. In this situation, the clip is said to be passive only, as its resiliency is not utilized to press the archwire down. Therefore, to avoid pain to the patient, archwires must be selected dependent on the progress of the orthodontic treatment which keep the clip in a so-called active condition in which the resilient effect of the clip only is utilized, i.e. the catching end portion of the clip must not engage the cover portion of the catching groove, rendering the clip passive.

### SUMMARY OF THE INVENTION

The invention has been established in view of the above mentioned problems, and it is an object of the invention to offer an orthodontic bracket which always has an active effect irrespective of the gage of the archwire inserted into the archwire slot and which reduces pain to the patient if an archwire of a gage is used which causes a considerable deflection of the clip engaging the archwire.

For accomplishing this and other objects of the invention, the invention as set forth is an orthodontic bracket comprising a base having a rear side for attachment to a tooth and a front side opposite to said rear side, a bracket main body extending from the front side of said base and having a first wing and a second wing, a groove-shaped archwire slot formed along a mesiodistal direction in the bracket main body, for holding an archwire therein between said first and second wings, a clip having a substantially belt shape and being curved substantially in a U-shape for covering at least one part of an opposite side to the base in the archwire slot, the clip having an end portion provided at an upper part thereof and a rotating supporter provided at a lower part thereof, said clip having a notch in a middle of its end portion, wherein the upper part of said clip at least partially covering the first wing has a length that does not extend beyond said archwire slot in a closing position of said clip, and said notch has a length that extends beyond said archwire slot in the closing position of said clip into a region occupied by said first wing delimiting one lateral side of said archwire slot.

According to a preferred embodiment, the upper part of the clip includes a hole in axial prolongation to the notch, the hole being adapted to receive an orthodontist's tool for opening and closing the clip.

According to another preferred embodiment, the second wing of the bracket main body extends into a height level which is higher than that of the first wing at an edge where said first wing and the archwire slot join one another. Thereby, the free edge of the end portion of the clip bifurcated by the notch is protected against unintentional opening movements by foreign matter, like food upon masticating.

### BRIEF DESCRIPTION OF THE DRAWINGS

FIG. 1 is a perspective view showing an orthodontic bracket according to the invention;

FIG. 2 is a side view of an orthodontic bracket featuring the present invention;

FIG. 3 is a top view of the bracket of FIG. 1;

FIG. 4 is a sectional view in a direction perpendicular to a plane cutting an archwire inserted into the archwire slot in its longitudinal direction, and

FIGS. 5a-5c show a side view of another embodiment of the invention in different positions of the clip.

### DETAILED DESCRIPTION OF PREFERRED EMBODIMENTS

A detailed explanation will be given of an embodiment of the invention with reference to the accompanying drawings. Identical or corresponding reference numbers will be given to the same elements of the invention to simplify the explanation.

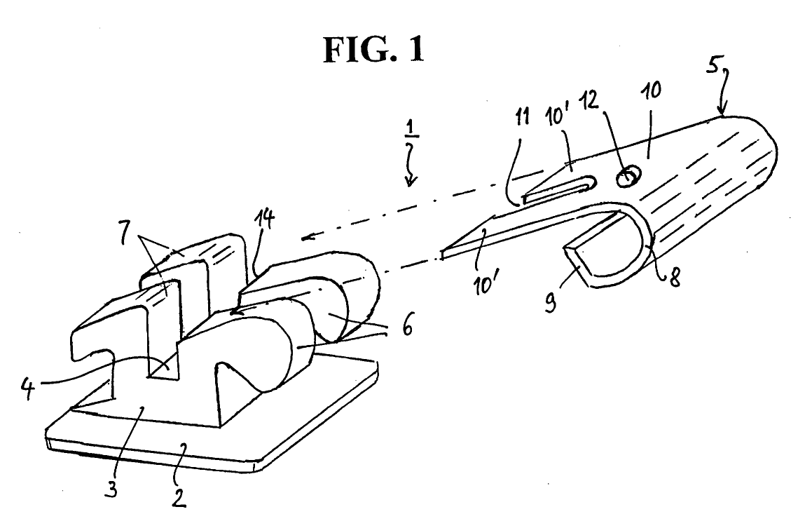

As shown in FIG. 1, orthodontic bracket 1 has a face-shaped base 2 having a rear side adapted to firmly attach to tooth surfaces, a bracket main body 3 disposed upon a front side of base 2, a groove-shaped archwire slot 4 formed in bracket main body 3 and a clip 5, preferably made from spring steel and attachable to bracket main body 3.

Archwire slot 4 extends in a masiodistal direction of bracket 1 and is adapted for holding an archwire therein (not shown) between first and second wings 6 and 7 of bracket main body 3 extending laterally of archwire slot 4. First and second wings 6, 7 are each divided by a gap so that each wing is formed as a twin.

Clip 5 is formed by a leaf spring and has a U-shaped arc 8 of approximately 150° to 180° arc length to which essentially straight first and second legs 9 and 10 of different length are connected. Legs 9 and 10 form an angle between one another of approximately 90°, so that they are able to essentially enclose first wing 6 of bracket main body 3 when clip 5 is mounted to bracket main body 3. The longer second leg 10 is bifurcated by a notch 11 having a length which is longer than the width of archwire slot 4, so as to form two essentially parallel fingers 10′. In axial alignment with notch 11, a hole 12 is provided in second leg 10 above notch 11.

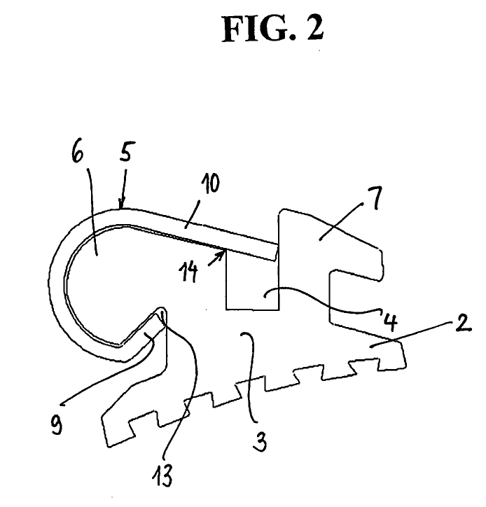

According to FIG. 2, the shorter first leg 9 of clip 5 is disposed in a groove 13. Groove 13 is formed at the lower side of first wing 6 and its opening points toward base 2. Groove 13 has a generally wedge-shaped cross section and a bottom where an end edge of first leg 9 is supported. Clip 5 has a bias that results in first wing 6 being clamped by clip 5 in either position of clip 5. Concerning further details, reference is made to U.S. Pat. No. 5,562,444, all of which is incorporated herein by reference.

As can be seen in FIGS. 1 and 2, starting at the bottom of archwire slot 4, second wing 7 projects outward from the front side of base 2 to reach a height whereby the uppermost edge of second wing 7, the edge along the top of the lateral wall of archwire slot 4 defined by second wing 7, is higher than an edge 14 where an upper side of first wing 6 abuts the opposing lateral wall of archwire slot 4. Thus, in the closed position of clip 5, the free end of second leg 10 is protected against engagement by foreign matter that could result in an opening movement of clip 5.

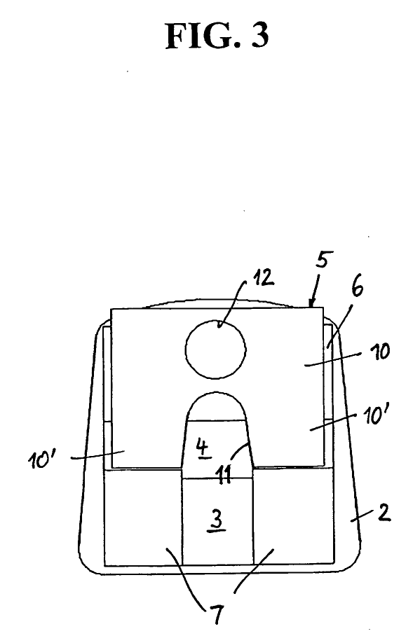

According to FIG. 3, clip 5 has a central notch 11 in the second leg 10 which bifurcates same. Notch 11 extends from the free end of second leg 10 for a length which is longer than the width of archwire slot 4. In axial alignment with notch 11, a hole 12 is provided in second leg 10 adjacent to a bottom of notch 11 that is adapted to receive a hook-like or needle-like tool (not shown) operated by an orthodontist for opening and closing clip 5. As may further be seen from FIGS. 1 to 3, the free ends of fingers 10′ of second leg 10 are not caught by any element laterally protruding from second wing 7, in contrast to the bracket of Orikasa shown in U.S. Pat. No. 6,776,613 as mentioned above.

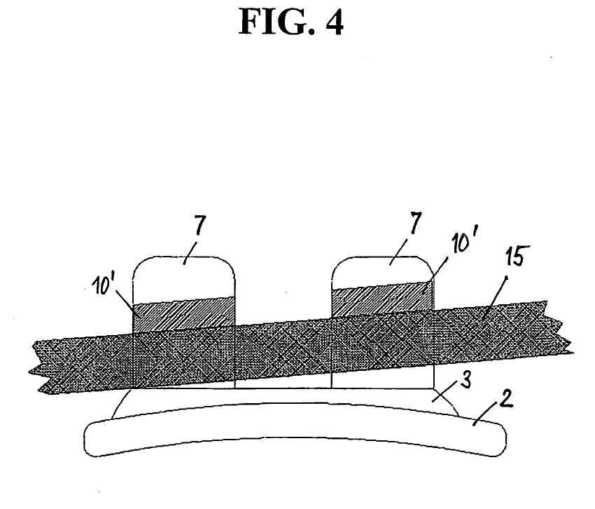

The effect of the bracket according to the present invention is shown in FIG. 4. FIG. 4 is a sectional view in the mesiodistal direction of the archwire slot, showing an archwire 15 inserted into the archwire slot of the bracket main body 3. In practice, there are often malpositions of teeth of a patient that will result in an archwire that has been inserted into the archwire slot of a bracket mounted to a tooth extending at an angle with respect to the bottom of the archwire slot. This is true even if the resilient clip presses the archwire in the direction of the bottom of the slot.

The result of this inclination is that the clip in the prior art engages the archwire with only one edge of its longer leg. The inherent rigidity of the clip's material in transverse direction of the clip is such, however, that it has the effect that the resilient force of nearly the whole cross section of the clip acts upon the archwire. In some cases, the force is so large that pain is caused to the patient. In such cases, archwires of reduced cross section must be selected in the beginning stage of the treatment and, in steps, exchanged with archwires of larger cross sections as treatment progresses.

In contrast, in the present invention, the longer second leg 10 of clip 5 is bifurcated by notch 11 so that two parallel fingers 10″ are formed that are able to develop their own resilient forces independent of one another. The fingers 10″ are able to yield independently of one another so that the total load acting on the archwire is partially relieved. This is clearly seen in FIG. 4 where the left finger 10′ follows archwire 15 to a large extent, so that the force acting on archwire 15 by the left finger 10′ is reduced with respect to the force exerted by the right finger 10′ upon archwire 15.

Thus, through use of the present invention, it becomes possible to utilize archwires of a relatively large cross section even in an early stage of the orthodontic treatment of a patient. This is in contrast to treatment in the past where, at early stages of the treatment, archwires having comparatively small cross sections must be used to avoid pain to the patient.

Furthermore, notch 11 provides a better view of the archwire 15 during its mounting and when closing clip 5. In addition, the amount of material visible to others is reduced so that the optical appearance of the bracket is improved.

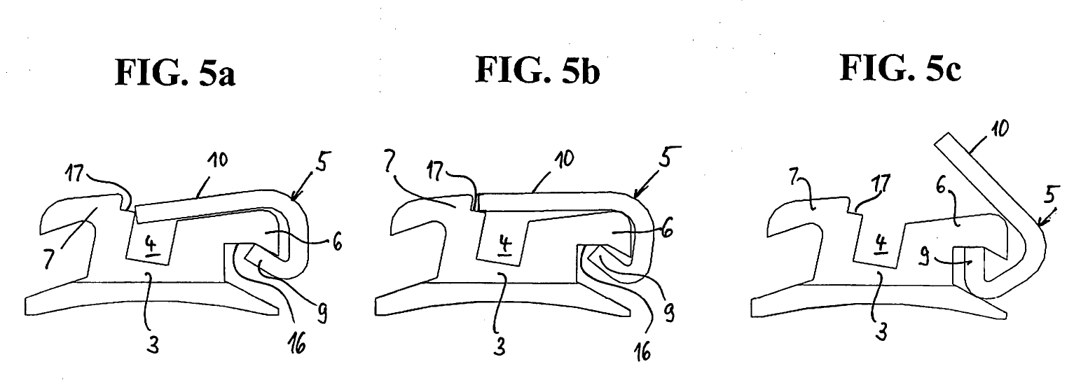

FIGS. 5a through 5c show another embodiment of the invention at three different positions of clip 5. These different positions are enabled by a guide face 16 formed at a lower side of first wing 6. According to the drawings, second wing 7 is provided with a recessed step 17 at an upper mesiodistally extending edge of archwire slot 4. As will be understood from a comparison of FIGS. 5a and 5b, the end of first leg 9 of clip 5 may be slid on guide face 16 in a direction normal to the mesiodistal extension of archwire slot 4, so that the free end of second leg 10 of clip 5 may either drop into archwire slot 4 or may rest on recessed step 17 of second wing 7.

In the first-mentioned position, shown in FIG. 5a, the longer leg 10 of clip 5 is able by its inherent resiliency to press an archwire (not shown), the archwire having a dimension to fill slot 4, onto the bottom of slot 4. This is the so-called active position mentioned above. In the other position of clip 5, shown in FIG. 5b, an archwire filling slot 4 is relieved of the resilient force of clip 5. This is the so-called passive position of clip 5. Furthermore, in either position of clip 5 shown in FIGS. 5a and 5b, clip 5 may be pivoted up into the position shown in FIG. 5c, where archwire slot 4 is exposed to allow the archwire (not shown) to be inserted into or removed from slot 4. This is necessary a plurality of times in the course of an orthodontic treatment to exchange archwires. In this opened position, clip 5 is held in a stable condition at first wing 6 by its inherent resiliency. In this regard, see U.S. Pat. No. 5,562,444 to Heiser et al., all of which is incorporated herein by reference.

By means of the embodiment shown in FIGS. 5a to 5c, when at an early stage of orthodontic treatment where the use of an archwire of large cross section in combination with the resilient force of a clip in its active position creates effects on the respective tooth to which the bracket is adhered that are so strong that they cause pain to the patient, bringing clip 5 into the passive position shown in FIG. 5b will alleviate those effects to a considerable amount such that the situation may be more comfortable to the patient. Thus, making use of the bracket of this invention permits a reduction in the number of archwire exchanges during an orthodontic treatment, as two subsequent steps in the treatment may be conducted with a single archwire by merely sliding clip 5 into the proper positions.

One skilled in the art will understand that the embodiment shown in FIGS. 5a to 5c can be realized using a clip having a bifurcated longer second leg as explained above with respect to FIGS. 1 to 4, thereby achieving the same beneficial effects as explained with reference to the embodiment of the clip seen in FIGS. 1 to 4.

While the principals of the invention have been shown and described in connection with a specific embodiment, it is to be understood that such embodiment is by way of example and not limiting. Consequently, variations and modifications commensurate witch the above teachings and with the skill and knowledge of the relevant prior art, are within the scope of the present invention. The embodiment described herein is intended to illustrate the best mode of practicing the invention and to enable others skilled in the art to utilize the invention in such, or other embodiments and with various modifications required by the particular application or use of the present invention. It is intended that the appended claims be construed to include alternative embodiments to the extent permitted by the prior art.

1. An orthodontic bracket comprising:
a base comprising a rear side for attachment to a tooth and a front side opposite to said rear side,
a bracket main body extending from the front side of said base and having a first wing and a second wing,
a groove-shaped archwire slot formed along a mesiodistal direction in the bracket main body, for holding an archwire therein between said first and second wings,
a clip having a substantially belt shape and being curved substantially in a U-shape for covering at least one part of an opposite side to the base in the archwire slot, the clip having an end portion provided at an upper part thereof and a rotating supporter provided at a lower part thereof and engaged at a lower side of said first wing, said clip having a notch in a middle of its end portion,
wherein the upper part of said clip at least partially covering the first wing has a length that does not extend beyond said archwire slot in a closing position of said clip, and said notch has a length that extends beyond said archwire slot in the closing position of said clip into a region occupied by said first wing delimiting one lateral side of said archwire slot.

2. The bracket of claim 1 wherein the second wing of the bracket main body extends into a height level which is higher than that of the first wing at an edge where said first wing and the archwire slot join one another.

3. The bracket of claim 1 wherein the first part of the clip includes a hole in axial alignment with the notch.

4. The bracket of claim 3 wherein the second wing projects outward from the front side to a height that is greater than a height of an edge where the first wing abuts the archwire slot.

5. An orthodontic bracket comprising:
a base having a rear side adapted for attachment to a tooth and a front side opposite to the rear side;
a bracket main body extending from the front side and having a first wing and a second wing;
a groove-shaped archwire slot formed along a mesiodistal direction in the bracket main body, the archwire slot being adapted for holding an archwire therein between the first and second wings; and
a substantially belt-shaped clip having a middle portion curved substantially in a U-shape and first and second legs connected at respective ends of the middle portion, the second leg having a length greater than a length of the first end and the second leg being bifurcated by a notch having a length greater than a width of the archwire slot.
